(19) United States
(12) Patent Application Publication
(10) Pub. No.: US 2017/0291395 A1
(43) Pub. Date: Oct. 12, 2017

(54) BASELESS DOUBLE-SIDED ADHESIVE SHEET OR TAPE, AND METHOD FOR MANUFACTURING THE SAME

(71) Applicant: KYODO GIKEN CHEMICAL CO., LTD., Tokorozawa-shi (JP)

(72) Inventors: Hisashi Hamano, Tokorozawa-shi (JP); Fumiko Watanabe, Tokorozawa-shi (JP)

(21) Appl. No.: 15/468,165

(22) Filed: Mar. 24, 2017

(30) Foreign Application Priority Data
Apr. 6, 2016 (JP) 2016-76583

(51) Int. Cl. B32B 7/12; B32B 37/15; B32B 37/12; B32B 27/40; B32B 27/30

(52) U.S. Cl. CPC B32B 7/12; B32B 27/40; B32B 27/308; B32B 37/12; B32B 37/15; B32B 2405/00; B32B 2309/105

(57) ABSTRACT

To provide a baseless double-sided adhesive sheet or tape that is configured such that adhesive does not exude during storage, or moreover during slitting to a predetermined size, or the like, and that is also capable for exhibiting the desired performance of having a cohesive force that resists peeling, without sacrificing the initial adhesive strength, and to provide a method for manufacturing the same.

In the baseless double-sided adhesive sheet or tape, an adhesive layer formed from an adhesive serves as a center layer, and adhesive layers and formed from an adhesive are layered onto a front face and a rear face of the adhesive layer serving as the center layer. Fibers are least dispersed in the adhesive layer serving as the center layer, and the adhesive layer serving as the center layer between the adjacent adhesive layers has a relatively high fiber density and relatively low flowability.

### BACKGROUND OF THE INVENTION

### 1. Field of the Invention

The present invention relates to a double-sided adhesive sheet having no base. The present invention relates to a baseless double-sided adhesive sheet or tape obtaining a predetermined adhesive strength in addition to having a stable shape and thinness well-suited for: adhering to films, paper, printed articles, and the like; circuit board lamination and fixing of reinforcement plates; joining car interior molding materials; and the like. The present invention also relates to a method for manufacturing the same.

Note that the term “sheet” in the present application is used with the meaning including “film”.

### 2. Description of the Related Art

Hitherto, for an adhesive tape formed with an adhesive layer by coating an adhesive onto a base, an adhesive tape has been proposed (for example, Japanese Patent Number 4739766 and Japanese Utility Model Application Laid-Open No. H07-40756) in which the adhesive layer is physically hardened and fibers are dispersed in the adhesive, and pseudo-crosslinks are formed in the adhesive layer by the fibers entwining to prevent flow of the adhesive.

'9766 describes an affixing material including a support body and an adhesive layer provided on the support body. The adhesive layer includes a mesh structure formed by fibers partially joining to one another.

Further, '0756 proposes an adhesive tape in which short fibers are dispersed in an adhesive layer formed on a rear face of a tape base.

As described above, the affixing material of '9766 and the adhesive tape of '0756 employ bases that support and hold the adhesive.

Double-sided adhesive tapes have similarly required a base hitherto for preventing adhesive flow and counteracting blocking when being unwound from a tape arrangement with adhesive coating onto both sides of the base.

A base is thus generally demanded in an adhesive tape to prevent blocking of a release paper caused by the adhesive layer exuding and to perform the role of suppressing or preventing deformation or flow of the adhesive layer (namely, to stabilize the dimensions), regardless of whether the adhesive tape is single-sided or double-sided. Configurations divided into a base layer and an adhesive layer have accordingly come to be employed, with an adhesive supported on a base that does not necessarily contribute to adhesive strength.

Note that paper, non-woven fabrics, stretched PET films, cloths, and the like have been employed as bases for use in double-sided adhesive tapes, and predetermined adhesives have been coated onto the front face and rear face of these bases.

However, double-sided adhesive tapes employing bases are higher in cost due to employing the base, and in cases in which a non-woven fabric, paper, or the like is employed as the base, the adhesive needs to be impregnated into the base, and problems arise of resource usage and not being able to reduce production effort.

For example, in cases in which a three-layered double-sided adhesive tape includes a base layer and an adhesive layer formed of an acrylic resin provided on the front and rear faces of the base layer, wet-laid rayon non-woven fabric of from 10 gm² to 14 g/m² is employed as the base layer. In such cases, when coating the adhesive onto the non-woven fabric, a predetermined amount of adhesive needs to be impregnated (to permeate) into the non-woven fabric in order to prevent delamination of the non-woven fabric, in addition to the amount (thickness) of adhesive required to exhibit adhesive strength. The impregnation amount (basis weight) corresponds to from 30 g/m² to 60 g/m², and, in terms of thickness, occupies from 25% to 50% of the overall 120 μm finished thickness of the double-sided tape. However, if the basis weight of the wet-laid rayon non-woven fabric is from 8 g/m² to 10 g/m² or less, then the resultant sheet is fragile, making winding and feeding difficult.

Further, when a rayon non-woven fabric having high absorbency is employed, the moisture content of the acrylic resin employed as the adhesive is approximately 0.3%, compared to a moisture content of the non-woven fabric of from approximately 2% to approximately 8%. Behavior variables in the base layer and the adhesive layer related to swelling and contraction arising from absorption and desorption of moisture therefore differ from each other by an order of magnitude in units and time.

Further, when a stretched PET film is employed as the base layer instead of the non-woven fabric or paper described above, the PET resin starts to contract more in the transverse direction (TD) and the machine direction (MD) from around 120° C., i.e., the glass transition temperature (Tg) of the PET resin. Similar applies when a straight chain polyolefin-based film is employed as the base layer, and this contraction behavior causes stress on the adhesive layer, resulting in the adhesive layer peeling away from an adherend. Incidentally, there have been some proposals for a stretched release tape utilizing such a property applied to break an interface with the adhesive layer described above.

On the other hand, conventional baseless double-sided adhesive tapes do not include a base serving as a support body, and deformation and flow of the adhesive layer are therefore liable to occur. These phenomena are particularly notable when the thickness of the adhesive layer is thin. For example, when slitting from baseless double-sided adhesive tape in roll form to an appropriate width in the roll width direction to give tape with a predetermined width, there has been a problem of the adhesive layer exuding and adhering to the slitter knife.

Further, there have been cases in which the adhesive layer exudes during storage due to there being no base present, with blocking of the release paper occurring and rending the release paper unusable.

It has been necessary to make the adhesive layer higher in molecular weight (stiffer) and to increase the cohesive force of the adhesive layer in order to prevent adverse effects caused by the adhesive layer exuding as described above. This inevitably results in a product with low tackiness with the problem of a sacrifice in the desired initial adhesive strength.

In general, if the polymerized molecular weight of the adhesive is increased from 800,000 to 2,000,000, the adhesive exhibits high film formability but has reduced initial adhesiveness. Similarly, if the adhesive is highly crosslinked, OH functional groups and the like are blocked, reducing the adhesive strength exhibited such that predetermined characteristics are not obtained.

As described above, in known double-sided adhesive tapes employing a base, the properties of the adhesive are governed by the properties of the base in order to prevent blocking of the release paper and to suppress flow of the adhesive layer, such that adhesive performance is not sufficiently exhibited. However, the adhesive layer must be given a high molecular weight (stiffness) and increased cohesive force in conventional baseless double-sided adhesive tapes in order to prevent breaks from blocking of the release paper, and this causes a problem of inevitably creating a product with low tackiness. An object of the present invention is to provide a baseless double-sided adhesive sheet or tape having satisfactory flowability (bond strength) and shape retention ability (cohesive force) without employing a base, and a method for manufacturing the same.

### SUMMARY OF THE INVENTION

In the following explanation of the Summary, reference numerals are referred as of the Embodiment in order to easily read the present invention, however, these numerals are not intended to restrict the invention as of the Embodiment.

A baseless double-sided adhesive sheet or tape 1 of the present invention characterized in comprising:

an adhesive layer 3;

an adhesive layer 2 in which fibers 5 are dispersed provided on the adhesive layer 3; and

an adhesive layer 4 provided on the adhesive layer 2 in which the fibers 5 are dispersed; wherein
the adhesive layer 2 in which the fibers 5 are dispersed has a relatively higher fiber density and a relatively lower flowability than the adjacent adhesive layers 3, 4.

For the baseless double-sided adhesive sheet or tape 1, it is preferable that fiber content in the adhesive layer 2 in which the fibers 5 are dispersed is from 0.1 wt % to 5 wt % with respect to 100 wt % of adhesive solids; and fiber content in the adhesive layers 3, 4 adjacent to the adhesive layer 2 in which the fibers 5 are dispersed is from 0 wt % to 3 wt % with respect to 100 wt % of adhesive solids.

The adhesive layers 2, 3 and 4 are preferably made from an adhesive resin that includes an acrylic resin or a urethane-based resin as a main component.

As the fibers 5, it is preferable that fibers of PET, an olefin, rayon, vinylon, or nylon are used.

Preferably, a fiber diameter of the fibers 5 is from 0.05 denier to 100 denier, and a fiber length of the fibers 5 is from 1 mm to 10 mm.

Preferably, the total thickness of the adhesive layers 2 3 and 4 is from 5 μm to 1800 μm.

Preferably, a molecular weight of the adhesive layer 2 in which the fibers 5 are dispersed is from 100,000 to 1,500,000, preferably 150,000 to 1,500,000; and a molecular weight of the adhesive layers 3, 4 adjacent to the adhesive layer 2 in which the fibers 5 are dispersed is from 2,000 to 1,500,000.

Preferably, a ratio between an elongation ratio of the adhesive layer 2 in which the fibers 5 are dispersed and an elongation ratio of the adhesive layers 3, 4 adjacent to the adhesive layer 2 in which the fibers 5 are dispersed is from 1:1 to 1:20.

A method for manufacturing a baseless double-sided adhesive sheet or tape 1 of the present invention is characterized in comprising, by using a three-layer extruding die:

forming a film of an adhesive layer 2 in which fibers 5 are dispersed; and

forming films of adhesive layers 3, 4 having a lower fiber density and higher flowability than the adhesive layer 2 in which the fibers 5 are dispersed on a front face and a rear face of the adhesive layer 2 in which the fibers 5 are dispersed at the same time as forming the film of the adhesive layer 2 in which the fibers 5 are dispersed.

In the method for manufacturing a baseless double-sided adhesive sheet or tape 1,

film forming may be performed by simultaneously coating three layers onto a release sheet using the three-layer extruding die. An adhesive resin including a photopolymerization initiator may be employed in the adhesive layers 2, 3 and 4; and

film forming may be performed using the three-layer extruding die for three layers by simultaneously flow casting the three layers between two release sheets and irradiating with ultraviolet rays.

Dispersion of fibers in the adhesive layers 2, 3 and 4 may be achieved by adding the fibers 5 to the adhesive employed in the adhesive layers 2, 3 and 4 and agitating using an agitator.

### Advantageous Effects of Invention

The baseless double-sided adhesive sheet or tape 1 of the present invention has the fibers 5 dispersed in the adhesive layer to form a pseudo-crosslinking state, and the pseudo-crosslinking generated by the entwining of the fibers forms the adhesive layer, and makes the adhesive layer physically hard. More specifically, between adjacent adhesive layers, namely, between the adhesive layer (center layer) 2 and the adhesive layer 3, and also between the adhesive layer (center layer) 2 and the adhesive layer 4, the fiber density of the adhesive layer (center layer) 2 is relatively high and the flowability thereof is relatively low. The adhesive layer (center layer) adhesive layer 2 accordingly has some flowability, albeit lower flowability than that of the adhesive layers 3, 4, enabling a high the shape retention ability (cohesive force) of the double-sided adhesive tape overall to be maintained an extent that does not impair adhesive bonding properties. At the same time, the adhesive layers 3, 4 contacting the adherend have a low fiber density, enabling the flowability (adhesive bonding properties) thereof to be maintained. The above configuration is such although the adhesive does not exude during storage or when cutting to a predetermined size or the like, the initial bond strength is not sacrificed, and a desirable performance is obtained in also having a cohesive force to resist peeling.

In relation to cohesive force, moreover, due to fibers being dispersed in the baseless double-sided adhesive sheet or tape 1 of the present invention and the formation of mechanical pseudo-crosslinking, there is no impairment of functional groups and the like contributing to the adhesive bonding properties, and there is no lowering of the adhesive bonding properties exhibited, in contrast to ordinary crosslinking.

Moreover, in the present invention, due to there being no base employed, stress acting on the adhesive layers is dissipated and alleviated, adhesive bonding properties are exhibited, a resolution to blocking when unwinding the tape is achieved, and a reduction is obtained in the raw material burden, compared to when a base is employed.

Moreover, the problems of thickness, adhesive strength, and cost, which are problems not satisfied by providing a non-woven fabric, a stretched PET film, or the like as a base in an existing type of double-sided adhesive tape, can be solved.

### BRIEF DESCRIPTION OF DRAWINGS

FIG. 1 is a cross-section view illustrating an exemplary embodiment of the present invention.

FIG. 2 is a cross-section view illustrating another exemplary embodiment of the present invention.

FIG. 3 is a cross-section view illustrating yet another exemplary embodiment of the present invention.

### DETAILED DESCRIPTION OF THE PREFERRED EMBODIMENTS

Overall Configuration

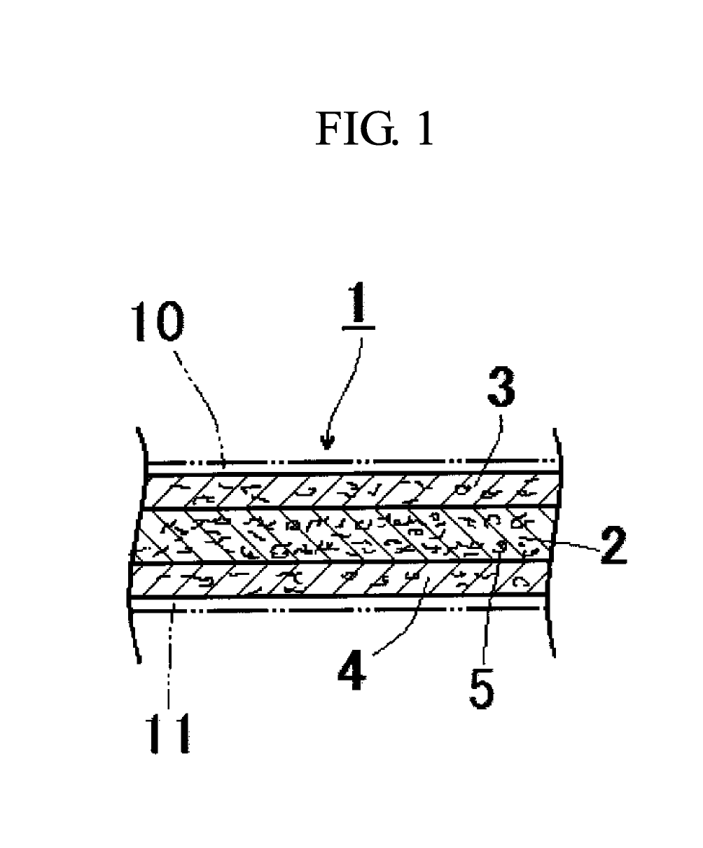

As illustrated in FIG. 1, the baseless double-sided adhesive sheet or tape 1 of the present invention includes at least three layers: an adhesive layer 2 formed by an adhesive, and a first adhesive layer 3 and a second adhesive layer 4 respectively provided on a front face and a rear face of the adhesive layer 2, which serves as a center layer (first adhesive layer 3/adhesive layer 2/second adhesive layer 4), and the baseless double-sided adhesive sheet or tape 1 does not employ a base.

Fibers 5 are dispersed in at least the adhesive layer 2, and the fiber density of the adhesive layer 2 is relatively high between adjacent adhesive layers, namely, between the adhesive layer (center layer) 2 and the adhesive layer 3 and between the adhesive layer (center layer) 2 and the adhesive layer 4.

Composition of Adhesive Layers 2, 3, and 4

An adhesive formed of an acrylic resin or a urethane-based resin is preferably employed in the adhesive that forms the adhesive layers of the present invention. Note that although the resin employed in the adhesive layer 2, the resin employed in the first adhesive layer 3, and the resin employed in the second adhesive layer 4 may be different resins, resins formed from the same monomer are preferably employed.

Acrylic Resin

In the acrylic resin, the main chain of the polymer may employ the following examples as the acrylic acid monomer and/or oligomer.

The examples include: alkylester acrylates such as 2-ethylhexyl acrylate, butyl acrylate, acrylic acid, ethyl acrylate, methyl acrylate, isobutyl acrylate, isononyl acrylate, dimethylaminoethyl acrylate, methoxyethyl acrylate, stearyl acrylate, methyl methacrylate, butyl methacrylate, 2-hydroxyethyl methacrylate, 2-hydroxypropyl methacrylate, cyclohexyl methacrylate, isooctyl acrylate, N-octyl acrylate, 2-hydroxyethyl acrylate, hydroxypropyl acrylate, trimethylolpropane trimethacrylate, tertiarybutyl methacrylate, propoxyethyl (meth)acrylate, butoxyethyl (meth)acrylate, or ethoxypropyl (meth)acrylate; dialkylaminoalkyl (meth)acrylates such as diethylaminoethyl(meth)acrylate; (meth)acrylamides such as (meth)acrylamide, N-methylol(meth)acrylamide, or diacetone acrylamidel; epoxy group-containing (meth)acrylic acid esters such as glycidyl(meth)acrylate; acrylic acid esters of alicyclic alcohols such as (meth)acrylic acid cyclohexyl; di(meth)acrylic acid esters of (poly)alkylene glycol such as di(meth)acrylic acid esters of ethylene glycol, di(meth)acrylic acid esters of diethylglycol, di(meth)acrylic acid esters of triethylene glycol, di(meth)acrylic acid esters of polyethylene glycol, di(meth)acrylic acid esters of dipropylene glycol, or di(meth)acrylic acid esters of tripropylene glycol; and vinyl acetate.

Two or more types of these main components may be combined and polymerized (copolymerized).

Examples of acrylic acid-type monomers having a functional group include unsaturated carboxylic acids such as itaconic acid, methacrylic acid, citraconic acid, norbornene dicarboxylic acid, acrylic acid, tetrahydrophthalic acid, crotonic acid, isocrotonic acid, or bicyclo[2.2.1] hepto-2-ene-5,6-dicarboxylic acid. Further, examples of derivatives thereof include: allylamine derivatives such as methacrylamine or N-methylacrylamine; N,N-dimethylacrylamide maleic acid anhydride; itaconic acid anhydride; citraconic acid anhydride; allylamine; N,N-dimethylaminopropylacrylamide; acrylamide; tetrahydrophthalic acid anhydride; a bicyclo[2,2,1] alkyl ester derivative of acrylic acid; vinylamine derivatives such as N-vinyldiethylamine, N-acetylvinylamine; acrylamide derivatives such as N-methylacrylamide; and hepto-2-ene-5,6-dicarboxylic acid anhydride. Examples that may be appropriately employed as the monomer of an amino group-containing acrylic acid having an ethylenically unsaturated bond include: alkylester derivatives of (meth)acrylic acid such as dimethylaminoethyl (meth)acrylate, phenylaminoethyl (meth)acrylate, aminoethyl (meth)acrylate, propylaminoethyl (meth)acrylate, aminopropyl (meth)acrylate, or cyclohexylaminoethyl (meth)acrylate; vinylamine derivatives such as allylamine, methacrylicamine, N-vinyldiethylamine, N-acetylvinylamine; acrylamide derivatives such as 6-aminohexylsuccinic acid imido-methylacrylamide; allylamine derivatives such as 2-aminoethyl succinic acid imide, or N-methyl acrylamide; and aminostyrenes such as acrylamide, N,N-dimethylacrylamide, N,N-dimethylaminopropylacrylamide, or N,p-aminostyrene.

Polymerization Initiator

A polymerization initiator may be employed to cause several types of the monomers described above to react after primary polymerization. Note that a photopolymerization initiator may be employed if necessary.

Examples of thermal types of the polymerization initiator include peroxides that are organic peroxides, organic peroxyketals, or azo compounds. Examples of organic peroxides include butyl cumyl peroxide, diacetyl peroxide, dilauroyl peroxide, dicumyl peroxide, dibutyl peroxide, dibenzoyl peroxide, didecanoyl peroxide, diisononayl peroxide, and 2-methyl pentanoyl peroxide. Examples of organic hydroperoxide types include butyl hydroperoxide. Examples of azo compounds include dimethyl valeronitrile, azobisisobutyronitrile, azobiscyclohexylnitrile, and azobisisobutyrate. Note that a single polymerization initiator may be employed alone, or a combination of two or more polymerization initiators may be employed.

Further, the acrylic resin may, for example, be produced by a conventionally known polymerization method such as solution polymerization or bulk polymerization using a polymerization initiator such as benzoyl peroxide or azobisisobutyronitrile.

Urethane-Based Resin

Further, the urethane-based resin employed in an adhesive layer of the present invention may be produced by reacting (urethane bonding) a polyol with a polyisocyanate compound. Examples of the polyol include polyoxyalkylene polyol, polyester polyol, polyether polyol, polylactone polyol, polyoxytetramethylene polyol, and polycarbonate polyol.

Further, examples of polyisocyanate compounds that may be employed include aromatic polyisocyanates, aliphatic polyisocyanates, and alicyclic polyisocyanates.

Examples of the aromatic polyisocyanate include 1,3-phenylene diisocyanate, 1,4-phenylene diisocyanate, 4,4′-diphenylmethane diisocyanate (referred to as MDI hereafter), 2,4-tolylene diisocyanate (referred to as 2, 4-TDI hereafter), 2,6-tolylene diisocyanate (referred to as 2,6-TDI hereafter), 4,4′-toluidine diisocyanate, 2,4,6-toluene triisocyanate, 1,3,5-triisocyanate benzene, dianisidine diisocyanate, 4,4′-diphenylether diisocyanate, 4,4′,4″-triphenylmethane triisocyanate, 1,4-tetramethylxylylene diisocyanate, and 1,3-tetramethylxylylene diisocyanate.

Examples of the aliphatic polyisocyanate include trimethylene diisocyanate, tetramethylene diisocyanate, hexamethylene diisocyanate (HDI), pentamethylene diisocyanate, 1,2-propylene diisocyanate, 2,3-butylene diisocyanate, 1,3-butylene diisocyanate, dodecamethylene diisocyanate, and 2,4,4-trimethylhexamethylene diisocyanate.

Examples of the alicyclic polyisocyanate include 3-isocyanatomethyl-3,5,5-trimethyl cyclohexylisocyanate (IPDI), 1,3-cyclopentane diisocyanate, 1,3-cyclohexane diisocyanate, 1,4-cyclohexane diisocyanate, methyl-2,4-cyclohexane diisocyanate, methyl-2,6-cyclohexane diisocyanate, 4,4′-methylene bis(cyclohexyl isocyanate), 1,4-bis(isocyanatomethyl)cyclohexane, and 1,4-bis(isocyanatomethyl)cyclohexane.

Crosslinking Agent

A crosslinking agent can be added to the adhesive layer of the acrylic resin or the urethane-based resin if necessary. Examples of the crosslinking agent that may be employed include polyisocyanates such as tolylene diisocyanate, diphenylmethane diisocyanate, hexamethylene diisocyanate, isophorone diisocyanate, or xylylene diisocyanate.

Other examples include metal chelate-based crosslinking agents, crosslinking agents including an epoxy group, and melamine-based crosslinking agents.

Examples of metal chelate-based crosslinking agents include Ni, Zn, Al, In, Ca, Mg, Mn, Sr, Cu, Fe, La, Sn, and Ti. Of these, Al is preferable from the viewpoint of transparency.

A metal chelate-based crosslinking agent may be employed in combination with one type of organic compound selected from isocyanate-based, epoxy-based, or melamine-based compounds.

Two or more out of trimethylolpropane triglycidyl ether tetraglycidyl-m-xylene diamine, bisphenol A, glycerin triglycidyl ether, diglycidylaniline, diglycidylamine, and the like may be employed in combination as the crosslinking agent that includes an epoxy group.

Fibers

Although the hydrophobicity of PET, olefin-based species, or the like is preferable from the viewpoint of resistance to moisture absorption, fibers such as rayon, vinylon, or nylon may be employed as the fibers 5 dispersed in the adhesive layers 2, 3, and 4 of the present invention from the viewpoint of heat tolerance. Note that a single type of fiber may be employed alone, or plural types of fiber may be employed in combination.

In the present invention, it is sufficient to disperse the fibers 5 in at least the adhesive layer 2. The first adhesive layer 3 and the second adhesive layer 4 can contain none of the fibers 5 at all (a fiber density of zero), or can have the fibers 5 dispersed therein with, as described in the Examples given later, the fiber density of the first adhesive layer 3 and the second adhesive layer 4 lower than the fiber density of the adhesive layer (center layer) 2.

The fiber diameter of fibers that may be preferably employed in the present invention is from 0.05 denier to 100 denier (from 0.01 μm to 200 μm diameter), is preferably from 1 denier to 10 denier (from 15 μm to 60 μm diameter), and is more preferably from 0.5 denier to 4 denier (from 3 μm to 40 μm diameter).

The fiber length of fibers that may be preferably employed in the present invention is from 1 mm to 10 mm, 7 mm or less is preferable and 5 mm or less is more preferable from the viewpoint of dispersibility.

Fiber Density

In the adhesive layer 2 of the present invention, the fibers are dispersed in the adhesive to suppress flow of the adhesive. Pseudo-crosslinks produced by the fibers entwining are formed in the adhesive layer and physically harden the adhesive layer.

In the baseless double-sided adhesive sheet or tape 1 of the present invention, the fibers are dispersed in the adhesive layer 2, and the adhesive layers 3 and 4 either contain none of the fibers at all (fiber density of zero), or the fibers are dispersed in the adhesive layers 3 and 4 such that the fiber density is relatively higher in the adhesive layer (center layer) 2 than in the adjacent adhesive layers 3 and 4. This lowers the flowability at the same time, and gives a configuration in which the fiber density differs in the thickness direction between the center layer and the adhesive layers adjacent to the center layer.

The adhesive layers 3 and 4 in contact with the adhesive target thus have low fiber density and maintain flowability (adhesive bonding properties). However, the adhesive layer (center layer) 2 has high fiber density and is physically hard compared to the adhesive layers 3 and 4. The adhesive layer (center layer) 2 has flowability, although this flowability is inferior to that of the adhesive layers 3 and 4. This configuration contributes to the shape retention ability of the double-sided adhesive tape overall to an extent that does not impair adhesive bonding properties, and is a configuration in which the adhesive does not exude during storage of the baseless double-sided adhesive sheet or tape 1, and also when cutting or the like. Accordingly, when cutting the baseless double-sided adhesive sheet or tape 1, adhesive does not adhere to the cutter knife, enabling cutting processes to be performed smoothly.

Thus, in the baseless double-sided adhesive sheet or tape 1 of the present invention, a region between layers in the thickness direction uses another mechanism instead of intermolecular crosslinks or polymerization. Namely, a fiber density gradient is formed by pseudo-crosslinking in a polymer layer, forming what is known as degree of pseudo-crosslinking gradient from the center in the thickness direction. The baseless double-sided adhesive sheet or tape 1 is accordingly able to exhibit excellent adhesive strength by satisfying the conflicting demands for shape retention ability (cohesive force) and flowability (bond strength).

Note that the size of the monomer or oligomer, which is an adhesive resin employed in the present invention, is of the order of nanometers, and is estimated to be approximately 1/100,000 of the size of the fibers. For example, the size of the monomer or oligomer is approximately 0.005 μm compared to a fiber length of approximately 5 mm, and the fibers do not hinder the chemical equilibrium of the adhesive resin or the oligomer. Further, the fibers improve a function of absorbing the stress to the adhesive layer when chemical equilibrium has been established.

The content of the fibers 5 in the adhesive layer (center layer) 2 is preferably from 0.1 wt % to 5 wt % with respect to 100 wt % of adhesive solids, and is more preferably from 0.5 wt % to 2 wt % with respect to 100 wt % of adhesive solids. The content of fibers in the adhesive layers 3 and 4 is preferably from 0 wt % to 5 wt % with respect to 100 wt % of adhesive solids, and is more preferably from 0 wt % to 1.5 wt % with respect to 100 wt % of adhesive solids, such that the fiber density of the adhesive layer (center layer) 2 is relatively high.

As described above, the adhesive layers 3 and 4 may have a fiber content of zero, or the fiber density of the adhesive layers 3 and 4 may be lower than that of the adhesive layer 2.

Note that if the content of the fibers exceeds a fiber content of 3%, the fibers (paper) governs the adhesive layer and the flowability toward the adherend (wetting and followability) required by the adhesive layer is remarkably diminished and this is therefore not preferable.

Although similar advantageous effects to those of the fibers are also obtained when a powder is included in the adhesive layer instead of the fibers, when trying to achieve equivalent advantageous effects to those of fiber fragments, the characteristics of the adhesive are lowered by a factor of two or greater than two compared to cases in which fiber fragments are included, and this is not preferable.

Additives

The adhesive layer 2, the first adhesive layer 3, and the second adhesive layer 4 may be formed from an acrylic resin or a urethane-based resin as described above, and additives may also be added if desired, such as tackifying agents, softeners, fillers, antioxidants, crosslinking agents, colorants, or conductive materials.

Note that in cases in which, for example, calcium carbonate is added as a filler (bulking agent), the amount of calcium carbonate added to the adhesive layers 3 and 4 on the front and rear faces, is preferably zero or close to zero in order to maximize the adhesive strength exhibited. However, since the center layer 2 functions to support the adhesive layers 3 and 4, the amount of calcium carbonate added to the center layer 2 may be from 5 wt % to 100 wt % with respect to 100 wt % of adhesive resin solids.

In cases in which a tackifier (tackifying agent) is added so that the adhesive layers 3 and 4 on the front and rear faces exhibit adhesive strength by multiple mechanisms, from 5 wt % to 100 wt % may be added with respect to 100 wt % of adhesive resin solids. Tackifier need not be added to the center layer 2 since the center layer 2 functions to support the adhesive layers 3 and 4 on the front and rear faces.

For example, the following substances may be employed as a tackifier (tackifying agent) added to the initial polymer for use on the front face and the rear face; Rosins (for example, rosin, gum rosin, modified rosin, rosin ester), terpene phenol resin, terpene resin, synthetic petroleum resins (for example, isoprene, cyclopentadiene, 1,3-pentadiene, and 2-pentene copolymers, copolymers of 2-pentene and dicyclopentadiene, 1,3-pentadiene-based resins, copolymers of indene, styrene, methylindene, and α-methylstyrene), phenol resins, xylene resins, alicyclic petroleum resins, coumarone-indene resins, styrenic resins, and dicyclopentadiene resins.

Molecular Weight of Each Layer

The resin that forms the adhesive layer (center layer) 2 is preferably a resin having a greater molecular weight than the resin forming the first adhesive layer 3 and the resin forming the second adhesive layer 4; however, the resin that forms the adhesive layer (center layer) 2 may be the same as the resin forming the first adhesive layer 3 or the same as the resin forming the second adhesive layer 4.

The molecular weight of the resin that forms the adhesive layer 2 is, for example, from 150,000 to 1,500,000, is preferably from 150,000 to 500,000, and is particularly preferably from 300,000 to 800,000.

The molecular weight of the adhesive layers 3 and 4 is from 2,000 to 1,500,000, is preferably from 50,000 to 300,000, and is particularly preferably from 300,000 to 500,000.

Elongation Ratio of Each Layer

The elongation ratio of the adhesive layer 2 alone after film formation is preferably from 0 to 3.5 times, is more preferably from 0 to 2.5 times, and is particularly preferably 2 times or less from the viewpoint of properties of work such as cutting. Note that the elongation ratio is the “elongation” referred to in JIS Z 0237-1991.

The elongation ratio of the resin that forms the adhesive layer (center layer) 2 and the elongation ratio of the resins that form the first adhesive layer 3 and the second adhesive layer 4 are preferably similar values. For example, a ratio between the elongation ratio of the resin that forms the adhesive layer (center layer) 2 and the elongation ratio of the resin that forms the first adhesive layer 3 and the second adhesive layer 4 is from 1:1 to 1:20, is preferably from 1:1 to 1:10, and is particularly preferably from 1:2 to 1:5.

Film Thickness

Although the thickness of the adhesive layer 2 depends on the application and the adhesive material employed, the thickness of the adhesive layer 2 is preferably from 2 μm to 500 μm, and is more preferably from 5 μm to 200 μm.

The film thicknesses of the first adhesive layer 3 and the second adhesive layer 4 are each preferably from 4 μm to 250 μm, and more preferably from 15 μm to 100 μm.

The overall thickness including the adhesive layer 2 serving as the center layer is preferably from 8 μm to 1500 μm, and is more preferably from 15 μm to 200 μm.

Film Formation and Production

The form of the adhesive employed in film formation is not particularly limited. Various types of adhesive, such as a liquid form, an emulsion form, or a solvent-free form may be employed. Moreover, although the formation of the film of the adhesive layer of the present invention may be performed under air, the formation is more preferably performed under a nitrogen atmosphere with a film having a low gas and moisture vapor transmission rate progressively affixed to the front and rear during film forming. More preferably, a three-layer extrusion die is used to form the adhesive layers 3 and 4 at the rear and front at the same time as film forming the adhesive layer 2 (three layers). When doing so, the front face and the rear face are affixed with a PET film or the like having a low gas and moisture vapor transmission rate, and oxygen is blocked.

As an example, a method is given in which a resin compounded as described below is formed as a film, and the baseless double-sided adhesive sheet or tape 1 of the present exemplary embodiment is produced.

The adhesive layers 3 and 4 formed as films on both faces of the adhesive layer 2 (the front face and the rear face) are copolymers obtained by starting with an initial polymer that includes the acrylic monomers butyl acrylate and 2-ethylhexyl acrylate as main components and that includes the monomer at a weight average molecular weight (Mw) of from 50,000 to 100,000, and then adding a tackifier such as another acrylic acid, a vinyl monomer, or a terpene phenol.

Then, 0.7 wt % of short PET fibers having fiber diameters of 5 denier and lengths of 5 mm are added to 100 wt % of the copolymer and dispersed by an agitator.

The adhesive layer 2 on the other hand, employs as the adhesive the same copolymer as that of the adhesive layers 3 and 4, and the same type of added fibers are also employed with 2 wt % of the fibers added to 100 wt % of the copolymer and dispersed using an agitator.

The resin (adhesive) described above is then employed to produce the baseless double-sided adhesive sheet or tape 1 of the present exemplary embodiment by the following method.

Using a primary polymerized prepolymer obtained by applying a known aggregation polymerization method to an acrylic monomer, the resin agent for forming the first adhesive layer 3, the adhesive layer (center layer) 2, and the second adhesive layer 4 is foamed and dehydrated, and then flow cast to form a film.

Note that the film forming of the adhesive film of the first adhesive layer 3 and the second adhesive layer 4 may be film forming by general-purpose hot air drying.

The film formation head may be a knife-over-roll head, a reverse roll head, or the like; however, a simultaneous three-layer die head (three layer flow casting) is preferable from the viewpoint of eliminating processes.

A three-layer die is employed to flow cast three layers simultaneously onto a PE double-sided laminated paper silicone release film at a thickness of 100 μm by feeding an ultraviolet ray crosslinking acrylic syrup obtained by primary polymerization of the first adhesive layer 3 at a thickness of 35 μm (layer one) and the second adhesive layer 4 at a thickness of 35 μm (layer three), and by feeding an acrylic polymer in which the fibers described above have been dispersed at a thickness of 30 μm for the center layer 2 (layer two). Immediately after flow casting, a PET single-sided silyne release film (thickness of 25 μm, oxygen barrier) is affixed such that the release face is on the adhesive side to avoid oxygen damage from ultraviolet ray reactions, and ultraviolet ray irradiation is performed to obtain crosslinking in the adhesive layer (center layer) 2, the adhesive layer (front face layer) 3, and the adhesive layer (rear face layer) 4.

### EXAMPLES

Next examples of the present invention follow.

### Example 1: Three Layer Film Forming by Ultraviolet Ray Curing Reaction

The adhesive layers 3 and 4 serving as the front face layer and the rear face layer were obtained by preparing an acrylic syrup composition by dissolving 10 wt % of added hydrogenated terpene phenol (manufactured by Yasuhara Chemical Co., Ltd., YS Polyster UH) as a tackifier in 100 wt % of an acrylic syrup (syrup manufactured by Soken Chemical & Engineering Co., Ltd.; trade name WS) as a primary polymerized prepolymer obtained by applying an aggregation polymerization method to a monomer such as acrylic acid 2-ethylhexyl, acrylic acid butyl, or acrylic acid.

0.7 wt % of PET short fibers having a fiber diameter of 5 denier and a fiber length of 5 mm were added and dispersed in 100 wt % of this acrylic syrup composition using an agitator.

Further, 0.5 wt % of an acetophenone-based photopolymerization initiator (manufactured by Ciba Specialty Chemicals; trade name IRGACURE 184) was added to 100 wt % of this acrylic syrup composition, and after agitating, vacuum defoaming together with humidity reduction was performed at 10 kg/20 min.

Regarding the adhesive layer 2 serving as the center layer, 2 wt % of PET short fibers having fiber diameters of 5 denier and fiber lengths of 5 mm was added to 100 wt % of acrylic syrup (syrup manufactured by Soken Chemical & Engineering Co., Ltd.; trade name WS), as a primary polymerized prepolymer of the acrylic syrup composition described above, and dispersed using an agitator.

Similar to as described above, 0.5 wt % of an acetophenone-based photopolymerization initiator (Ciba Specialty Chemicals; trade name IRGACURE 184) was added to 100 wt % of this acrylic syrup composition, and after agitating, vacuum defoaming together with humidity reduction was performed at 10 kg/20 min.

The film formation of the three layers is performed by using a three-layer extruding die to perform flow casting between two release films, described later, and irradiating using an ultraviolet black light.

The release film of the front face is a 25 μm transparent PET stretched film (single-sided silicone release coated product) transmissive to ultraviolet rays having a release coated face with a moisture vapor transmission rate of 50 g (g/m²·0.24 hr/24 μm thickness). On the other hand, the double-sided release silicone film at the rear face (lower face) is PE double-sided laminated release paper having a thickness of 100 μm.

Simultaneous flow casting and film forming in the extrusion of the three layers (layer one, layer two, and layer three) using the three-layer die is performed as follows.

Layer one (front face: first adhesive layer 3) has a thickness of 20 μm, layer two (center: adhesive layer 2) has a thickness of 10 μm, and layer three (rear face: second adhesive layer 4) has the same thickness as the first layer.

These layers, layer one to layer three, are flow cast onto the release PET stretched film described above, and the 25 μm transparent release PET stretched film is immediately affixed to the front face (with the silicone release treated face on the inside), and the three layers then proceed to ultraviolet ray irradiation processing.

An adhesive composition body with a total thickness of 50 μm is obtained by irradiation with a black light by irradiating ultraviolet rays at a wavelength of from 350 nm to 375 nm for 5 minutes.

### Example 2: Solvated Layer Two Formation, Fiber Insertion into Layer Two

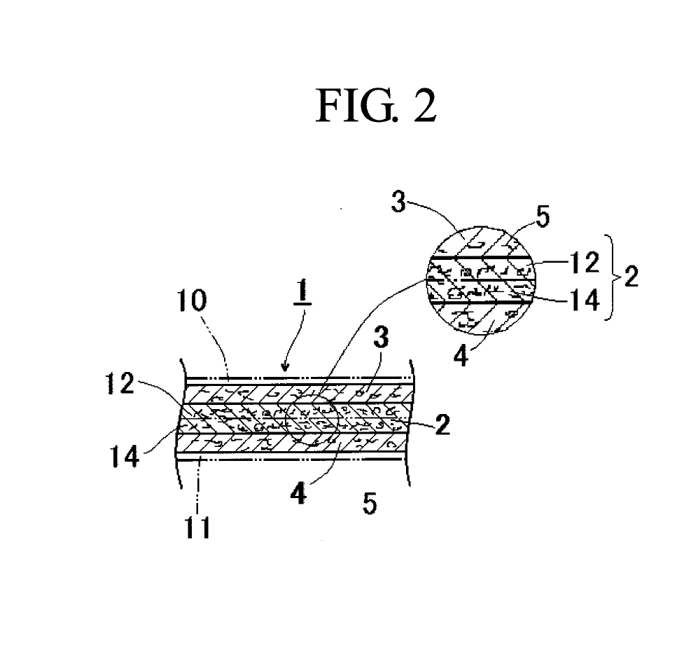

As illustrated in FIG. 2, Example 2 is a manufacturing method in which a structure is provided by: preparing a structure having the adhesive layer 3 in which the fibers 5 have been dispersed provided on a release paper 10 and an adhesive layer 12 in which the fibers 5 have been dispersed provided on the adhesive layer 3; preparing a structure having the adhesive layer 4 in which the fibers 5 have been dispersed provided on a release paper 11 and an adhesive layer 14 in which the fibers 5 have been dispersed provided on the adhesive layer 4; and providing the compatibilizing layer (adhesive layer) 2 by polymerizing the adhesive layer 14 with the adhesive layer 12.

The adhesive layers 3, 4, 12, and 14 employed a solvated acrylic composition (manufactured by Ipposha Oil Industries Co., Ltd., trade name 520), as a primary polymerized prepolymer obtained by applying a solution polymerization method to a monomer such as 2-ethylhexyl acrylate, butyl acrylate, or acrylic acid.

Further, 0.6 wt % of vinylon fibers 5 having fiber diameters of 4 denier and fiber lengths of 5 mm was added to 100 wt % of the solvated acrylic composition, were added to the adhesive layers 3 and 4, and agitation performed to disperse the fibers 5. Then, 0.5 wt % toluene diisocyanate (manufactured by Nippon Polyurethane Industry Co., Ltd.; trade name CORONATE L75) was added thereto, and, after agitating, vacuum defoaming together with reduction of air bubbles was performed at 10 kg/20 min.

In the adhesive layers 12 and 14, 1 part by weight of the vinylon fibers 5 having fiber diameters of 4 denier and fiber lengths of 5 mm was added to 100 wt % of the same solvated acrylic composition as that in the front face layer, and agitation performed to disperse the fibers 5. Then, 0.5 wt % of toluene diisocyanate (Nippon Polyurethane Industry Co., Ltd.; trade name CORONATE L75) was added thereto, and after agitating, vacuum defoaming together with reduction of air bubbles was performed at 10 kg/20 min.

Film forming (with drying at 110° C./2 min) was performed using a hand bar (15 mm diameter metal bar for testing) by coating the solvated acrylic composition (45% solids) onto 2 respective sheets of PE laminated release paper 10 and 11, in the order of the release paper 10/the adhesive layer 3/the adhesive layer 12 and in the order of the release paper 11/the adhesive layer 4/the adhesive layer 14 to give respective solids thicknesses of 25 μm. Two A4 size sheets were thereby obtained, and the adhesive layer 12 and the adhesive layer 14 were superimposed on each other to obtain a total thickness of the layers of 50 μm.

Note that although the fiber content of the adhesive layer 12 and the adhesive layer 14 were the same in the above Example, the fiber content of the adhesive layer 12 and the adhesive layer 14 may be different. However, bear in mind that the fiber density of the adhesive layer 12 is higher than the fiber density of the adhesive layer 3, and the fiber density of the adhesive layer 14 is higher than the fiber density of the adhesive layer 4.

### Example 3: Solvated Layer Two Formation, Fiber Insertion into Layer One

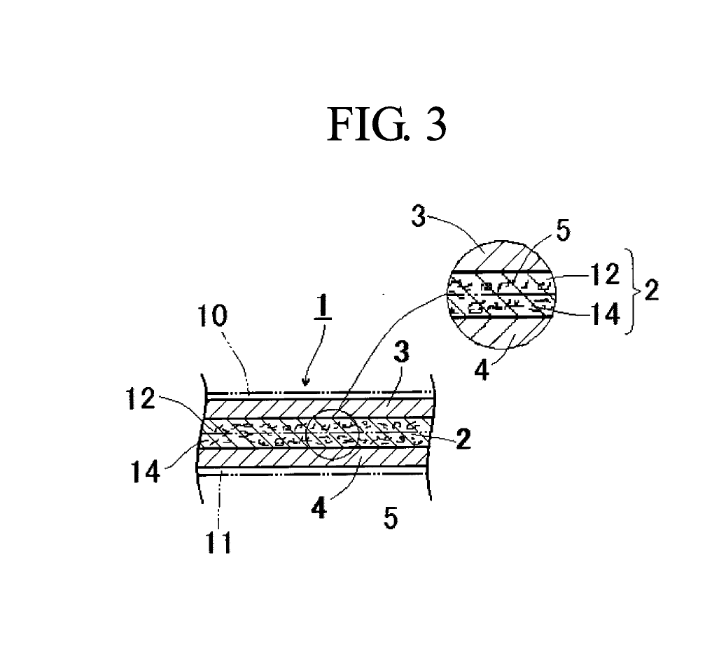

As illustrated in FIG. 3, Example 3 is a manufacturing method in which a structure is provided by: preparing a structure having the adhesive layer 3 provided on the release paper 10 and the adhesive layer 12 in which the fibers 5 had been dispersed provided on the adhesive layer 3; preparing a structure having the adhesive layer 4 provided on the release paper 11 and the adhesive layer 14 in which the fibers 5 had been dispersed provided on the adhesive layer 4; and providing a compatibilizing layer (adhesive layer) 2 by polymerizing the adhesive layer 14 with the adhesive layer 12.

The adhesive layers 3, 4, 12, and 14 employed a solvated acrylic composition (manufactured by Ipposha Oil Industries Co., Ltd.; trade name 520), as a primary polymerized prepolymer obtained by applying a solvent polymerization method to a monomer such as 2-ethylhexyl acrylate, butyl acrylate, or acrylic acid.

For the adhesive layers 3 and 4, 0.5 wt % of toluene diisocyanate (manufactured by Nippon Polyurethane Industry Co., Ltd.; trade name CORONATE L75) was added to 100 wt % of the solvated acrylic composition and agitation performed.

However, 0.6 wt % of the vinylon fibers 5 having fiber diameters of 4 denier and fiber lengths of 5 mm was added to 100 wt % of the solvated acrylic composition, were added to the adhesive layers 12 and 14, and agitation performed to disperse the fibers 5. Then, 0.5 wt % of toluene diisocyanate (manufactured by Nippon Polyurethane Industry Co., Ltd.; trade name CORONATE L75) was added thereto, and, after agitating, vacuum defoaming together with reduction of air bubbles was performed at 10 kg/20 min.

Film forming (with drying at 110° C./2 min) was performed using a hand bar (15 mm diameter metal bar for testing) by coating the solvated acrylic composition (45% solids) onto 2 respective sheets of PE laminated release paper 10 and 11, in the order of the release paper 10/the adhesive layer 3/the adhesive layer 12 and in the order of the release paper 11/the adhesive layer 4/the adhesive layer 14 to give respective solids thicknesses of 25 μm. Two A4 size sheets were thereby obtained, and the adhesive layer 12 and the adhesive layer 14 were superimposed on each other to obtain a total thickness of the layers of 50 μm.

### Comparative Example 1

A film was formed with a thickness of 50 μm using the same acrylic syrup as that of Example 1. The film formation method obtained the same release film as that of Example 1 by ultraviolet ray irradiation.

### Comparative Example 2

A film was formed with a thickness of 50 μm using the same solvated acrylic composition as that of Example 2. The film formation method obtained a release film by heat drying under the same conditions as in Example 2.

### Comparative Example 3

The same adhesive as that of Example 2 was formed as a film by coating using 12 g/m² of an existing type of wet-laid rayon non-woven fabric.

For the adhesive, similarly to in Example 2, A4 size sheets of the adhesive for the front face side and the rear face side were each obtained with similar thicknesses and film forming conditions, the rayon non-woven fabric described above was affixed to the adhesive sheet for the front face side, and the other adhesive sheet for the rear face side was then immediately affixed to the non-woven fabric face. Immediately afterward, pressure bonding was performed in order to prevent delamination of the non-woven fabric using rubber rolls at 30 kg/m of line pressure. Then curing was performed at 40° C./24 h to promote permeation into the non-woven fabric. The total thickness after 24 h was from approximately 68 μm to approximately 72 μm. Note that to the feel, the adhesive strength was reduced to half or less when touched.

### Comparative Example 4

A coated film was formed of the same adhesive as that of Example 2 using 12 g/m² of an existing type of wet-laid rayon non-woven fabric.

A4 size sheets of the adhesive at a thickness of 50 μm for the front face side and 50 μm for the rear face side were each obtained with similar thicknesses and film formation conditions, the rayon non-woven fabric described above was affixed to the adhesive sheet for the front face side, and the other adhesive sheet for the rear face side was affixed to the non-woven fabric face. Pressure bonding was performed in order to prevent delamination of the non-woven fabric using rubber rolls at 30 kg/m of line pressure, and then curing was performed at 40° C./24 h to promote permeation into the non-woven fabric, resulting in a total thickness of approximately 120 μm.

Results of the following test methods are listed in Table 1.

### Test Method

Adherend: SUS Plate and polyester film (25 μm thickness).
Adhesive Strength: Tested with a 25 mm sample width, using a 180° peel test (300 mm/min), at a temperature/humidity of 23° C./65% RH, with a dwell time of one hour after affixing.
Holding Power: Tested against stainless steel plate and PET film, with a load of 1 kg, a test sample area of 25 mm×25 mm, and a measurement temperature of 40° C., load time of 1 hour or less.

TABLE 1
Comparative Values of Adhesive Bonding properties

| | Adhesive Strength 1 h | |
|---|---|---|
| Production Example | (N/25 mm) | Holding Power (mm) |
| Example 1 | 16.4 | 0.5 |
| Example 2 | 13.2 | 0.5 |
| Example 3 | 14.5 | 0.5 |
| Comparative Example 1 | 15.2 | 1 |
| Comparative Example 2 | 13.5 | 1.5 |
| Comparative Example 3 | 2.5 | Fell down |
| Comparative Example 4 | 13 | 1 |

Evaluation of Comparative Experiment Results of Table 1

Referring to Table 1, in Comparative Example 4, which employed an existing type of wet-laid non-woven fabric, equivalent values are finally obtained for the adhesive strength by adding an amount of adhesive coating double that of Examples 1, 2, and 3. However, the total thickness is also double or greater, and there is the additional burden of using the non-woven fabric produced by a wet-lay method.

Comparative Example 3 employed the existing type of wet-laid non-woven fabric and was given a similar amount of adhesive to that in the Examples 1, 2, and 3, and was accordingly found to be completely unable to exhibit the performance of an adhesive.

It was found that the Examples 1, 2, and 3 containing the fiber fragments had reproducible adhesive performance without lowering the adhesive strength compared to Comparative Examples 1 and 2, which did not contain fiber fragments. The Examples 1, 2, and 3 containing fiber fragments also had values of holding power close to two times higher. The fiber fragments are thought to be producing mechanical pseudo-crosslinks without blocking the functional groups of the adhesive.

TABLE 2
Comparative Values of Physical Properties (Elongation)

| Production Example | Elongation % (25 mm) |
|---|---|
| Example 1 | 46 |
| Example 2 | 87 |
| Example 3 | 94 |
| Comparative Example 1 | 280 |
| Comparative Example 2 | 310 |
| Comparative Example 3 | 7 |
| Comparative Example 4 | 10 |

TABLE 3
Comparative Values of Physical Properties (Unwinding)

| Production Example | Assessment Value |
|---|---|
| Example 1 | Good |
| Example 2 | Good |
| Example 3 | Good |
| Comparative Example 1 | Marginal |
| Comparative Example 2 | Bad |
| Comparative Example 3 | Good |
| Comparative Example 4 | Good |

* Meaning of assessment values
No blocking phenomena: Good
Block phenomena: Bad
Slight blocking phenomena: Marginal

Evaluation of Comparative Experimental Results of Table 2 and Table 3

The values of the elongation ratio were suitably high for Comparative Example 1 and Comparative Example 2 since these examples did not include fibers. Incidentally, the difference in the values is due to the difference in extent of polymerization and extent of crosslinking. These elongation ratios of 280% and 310% cause notable blocking to occur when the tape is unwound. Further, when the tape is slit to 10 mm width, 20 mm width, or the like, cold flow (flowing) of the adhesive from the side ends occurs due to the tape winding pressure and the like.

The elongation ratios of the Comparative Examples 3 and 4 are values governed by the wet-laid non-woven fabric. Obviously, this is unrelated to movement of the adhesive layer and constraining blocking.

In contrast to these Comparative Examples, in the Examples 1, 2, and 3, the elongation ratio is suppressed to approximately ⅓ that of the original adhesive, and it was found that blocking does not occur.

### DESCRIPTION OF REFERENCE NUMERALS

1. Baseless double-sided adhesive sheet or tape
2. Adhesive layer (Center layer)
3. Adhesive layer (First adhesive layer)
4. Adhesive layer (Second adhesive layer)
5. Fibers
10. Release paper 10
12. Adhesive layer 12
14. Adhesive layer 14

1. A baseless double-sided adhesive sheet or tape, comprising:
an adhesive layer;
an adhesive layer in which fibers are dispersed provided on the adhesive layer; and
an adhesive layer provided on the adhesive layer in which the fibers are dispersed; wherein
the adhesive layer in which the fibers are dispersed has a relatively higher fiber density and a relatively lower flowability than adjacent said adhesive layers.

2. The baseless double-sided adhesive sheet or tape according to claim 1, wherein:
fiber content in the adhesive layer in which the fibers are dispersed is from 0.1 wt % to 5 wt % with respect to 100 wt % of adhesive solids; and
fiber content in the adhesive layers adjacent to the adhesive layer in which the fibers are dispersed is from 0 wt % to 3 wt % with respect to 100 wt % of adhesive solids.

3. The baseless double-sided adhesive sheet or tape according to claim 1, wherein:
the adhesive layer is made from an adhesive resin that includes an acrylic resin or a urethane-based resin as a main component.

4. The baseless double-sided adhesive sheet or tape according to claim 2, wherein:
the adhesive layer is made from an adhesive resin that includes an acrylic resin or a urethane-based resin as a main component.

5. The baseless double-sided adhesive sheet or tape according to claim 1, wherein:
the fibers are fibers of PET, an olefin, rayon, vinylon, or nylon.

6. The baseless double-sided adhesive sheet or tape according to claim 2, wherein:
the fibers are fibers of PET, an olefin, rayon, vinylon, or nylon.

7. The baseless double-sided adhesive sheet or tape according to claim 1, wherein:
a fiber diameter of the fibers is from 0.05 denier to 100 denier.

8. The baseless double-sided adhesive sheet or tape according to claim 2, wherein:
a fiber diameter of the fibers is from 0.05 denier to 100 denier.

9. The baseless double-sided adhesive sheet or tape according to claim 1, wherein:
a fiber length of the fibers is from 1 mm to 10 mm.

10. The baseless double-sided adhesive sheet or tape according to claim 2, wherein:
a fiber length of the fibers is from 1 mm to 10 mm.

11. The baseless double-sided adhesive sheet or tape according to claim 1, wherein:
the total thickness of the adhesive layers is from 5 μm to 1800 μm.

12. The baseless double-sided adhesive sheet or tape according to claim 2, wherein:
the total thickness of the adhesive layers is from 5 μm to 1800 μm.

13. The baseless double-sided adhesive sheet or tape according to claim 1, wherein:
a molecular weight of the adhesive layer in which the fibers are dispersed is from 150,000 to 1,500,000; and
a molecular weight of the adhesive layers adjacent to the adhesive layer in which the fibers are dispersed is from 2,000 to 1,500,000.

14. The baseless double-sided adhesive sheet or tape according to claim 2, wherein:
a molecular weight of the adhesive layer in which the fibers are dispersed is from 150,000 to 1,500,000; and
a molecular weight of the adhesive layers adjacent to the adhesive layer in which the fibers are dispersed is from 2,000 to 1,500,000.

15. The baseless double-sided adhesive sheet or tape according to claim 1, wherein:
a ratio between an elongation ratio of the adhesive layer in which the fibers are dispersed and an elongation ratio of the adhesive layers adjacent to the adhesive layer in which the fibers are dispersed is from 1:1 to 1:20.

16. The baseless double-sided adhesive sheet or tape according to claim 2, wherein:
a ratio between an elongation ratio of the adhesive layer in which the fibers are dispersed and an elongation ratio of the adhesive layers adjacent to the adhesive layer in which the fibers are dispersed is from 1:1 to 1:20.

17. A method for manufacturing a baseless double-sided adhesive sheet or tape, comprising, by using a three-layer extruding die:
forming a film of an adhesive layer in which fibers are dispersed; and
forming films of adhesive layers having a lower fiber density and higher flowability than the adhesive layer in which the fibers are dispersed on a front face and a rear face of the adhesive layer in which the fibers are dispersed at the same time as forming the film of the adhesive layer in which the fibers are dispersed.

18. The method for manufacturing a baseless double-sided adhesive sheet or tape according to claim 17, wherein:
film forming is performed by simultaneously coating three layers onto a release sheet using the three-layer extruding die.

19. The method for manufacturing a baseless double-sided adhesive sheet or tape according to claim 17, wherein:
an adhesive resin including a photopolymerization initiator is employed in the adhesive layers; and
film forming is performed using the three-layer extruding die for three layers by simultaneously flow casting the three layers between two release sheets and irradiating with ultraviolet rays.

20. The method for manufacturing a baseless double-sided adhesive sheet or tape according to claim 17, wherein:
dispersion of fibers in the adhesive layer is achieved by adding the fibers to the adhesive employed in the adhesive layer and agitating using an agitator.
